(19) United States
(12) Patent Application Publication
(10) Pub. No.: US 2018/0343782 A1
(43) Pub. Date: Dec. 6, 2018

(54) Root getter

(71) Applicant: Brian Pool, Eunice, NM (US)

(72) Inventor: Brian Pool, Eunice, NM (US)

(21) Appl. No.: 15/607,689

(22) Filed: May 30, 2017

(51) Int. Cl. A01B 1/16

(52) U.S. Cl. CPC A01B 1/16

(57) ABSTRACT

The Root Getter is the only product of its kind that features a steel head and pipe handle that functions optimally in all environments for added durability, flexibility, and convenience. What makes the Root Getter truly unique is its ground-breaking design that is structured to get the user off of the ground for a much higher level of accessibility as it completely eliminates the need to hunch over and extracts the very root of any weed through one simple motion.

### BACKGROUND OF THE INVENTION

### Field of the Invention

The present invention is a piece of hardware. More specifically, the present invention is a tool used for the removal of weeds.

### Description of the Related Art

There are currently no feasible products on the market that offer an effective way to get rid of weeds and prevent them from re-emerging. Comparable products on the market (such as garden hoes, dandelion diggers, weed twisters, etc.) only chop the root of the weed off which allows it to grow back and therefore, forces one to repeat the same process time and time again. Moreover, pulling weeds typically involves getting on one's knees and exerting the back area which can be very strenuous and even painful when dealing with old injuries.

### SUMMARY OF THE INVENTION

The present invention is a piece of hardware. More specifically, the present invention is a tool used for the removal of weeds.

The tool includes a handle and a head.

It is an object of the present invention to provide a tool with a ½″ metal pipe handle measuring 4 feet long and a V-shaped, steel head.

It is an object of the present invention to provide a tool that is easy to use by placing the slit located on head over base of weed desired for removal and extract root by pulling back pipe handle (or carrying out full motion) in a matter of seconds.

It is an object of the present invention to provide a tool that is readily available in all hardware and tools stores, home improvement stores, and gardening/lawn equipment stores.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of a root getter, in accordance with one embodiment of the present invention.

FIG. 2 illustrates an isometric view of a root getter, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

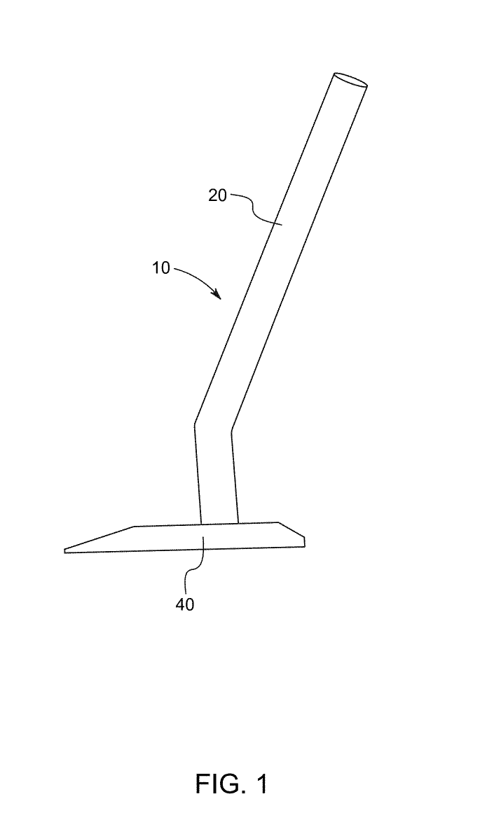

Referring now to FIG. 1, illustrated is a front view of a root getter 10, in accordance with one embodiment of the present invention.

In FIG. 1, illustrated is a front view of a root getter 10, including a body or handle 20 and a steel head 40.

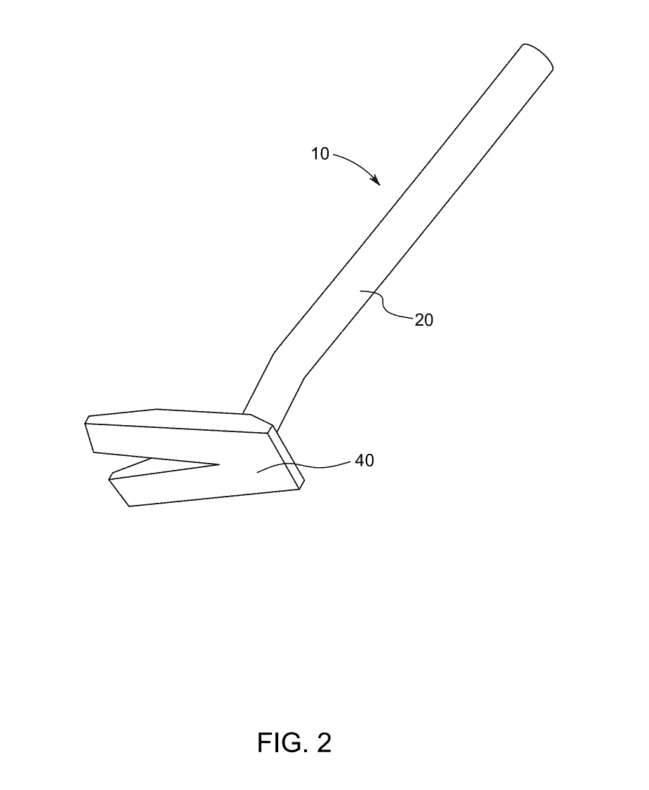

Referring now to FIG. 2, illustrated is an isometric view of a root getter 10, in accordance with one embodiment of the present invention.

In FIG. 2, illustrated is an isometric view of a root getter 10, including a body or handle 20 and a steel head 40.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A tool used for the removal of weeds, said tool comprising:
an elongate body with a first end and a second end;
said second end of the elongate body having a head.

2. The tool according to claim 1, wherein said elongate body is a ½″ metal pipe handle.

3. The tool according to claim 1, wherein said head is made of steel.

4. The tool according to claim 2, wherein said metal pipe handle measures 4 feet in length.

5. The tool according to claim 3, wherein said head is a V-shaped head.

6. The tool according to claim 5, wherein said V-shaped head has a slit.

7. The tool according to claim 6, wherein by placing said slit over a base of a weed allows for removal and extraction of a root by pulling back said pipe handle.
